(19) United States
(12) Patent Application Publication
(10) Pub. No.: US 2026/0180341 A1
(43) Pub. Date: Jun. 25, 2026

(54) MOTOR VEHICLE

(71) Applicant: AUDI AG, Ingolstadt (DE)

(72) Inventor: Jens MÖLLER-DÖLING, Ludwigsburg (DE)

(73) Assignee: AUDI AG, Ingolstadt (DE)

(21) Appl. No.: 19/127,197

(22) PCT Filed: Nov. 20, 2023
(86) PCT No.: PCT/EP2023/082386

§ 371 Date: May 5, 2025

(30) Foreign Application Priority Data
Jan. 12, 2023 (DE) 10 2023 100 652.5

(51) Int. Cl. H02J 7/00; B60K 15/05; B60L 53/10; B60L 53/16; B60L 53/30; H01R 13/502; H01R 13/52

(52) U.S. Cl. CPC H02J 7/00; B60L 53/11; B60L 53/16; B60L 53/30; H01R 13/502; H01R 13/5202; B60K 2015/0561

(57) ABSTRACT

A motor vehicle having a charging socket for a battery installed in the motor vehicle, a body with a rear wheel housing of a rear wheel, above which the charging socket is installed in the body, and a charging flap module with a charging flap which outwardly covers the charging socket, and which is open inwards. The wheel housing has an inner body section which delimits an inner dry region and an outer body section, which separates a wet region located between the inner and outer body section from the exterior of the motor vehicle, such that the wet region expands upwards in order to form a charging socket region. The charging socket is installed in an installation opening of the inner body section such that connection cables are guided off in the dry region.

### FIELD

The invention relates to a motor vehicle, having a charging socket for a battery installed in the motor vehicle, in particular a traction battery, a body with a rear wheel housing of a rear wheel, above which the charging socket is installed in the body, and a charging flap module with a charging flap which outwardly covers the charging socket and which opens inwardly.

### BACKGROUND

Electric vehicles or plug-in hybrids, which have an externally chargeable battery installed in the motor vehicle, in particular as a traction battery, usually comprise a charging socket covered by a charging flap, via which the motor vehicle can be connected to a charging device external to the vehicle, for example a charging station, in order to charge the battery. It was proposed to provide the charging socket in a region of the vehicle, i.e. on its outer skin, where the fuel filler flap with the fuel tank opening located behind it was previously located. This is usually above a rear wheel on one side of the vehicle.

In order to avoid impairments caused by a charging flap protruding from the motor vehicle, it has already been proposed in the prior art to use charging flaps that open inwards, for example in the manner of a sliding door. This was proposed, for example, in DE 10 2015 206 715 A1, which relates to a device for opening and closing a charging flap of a vehicle, in which the charging flap is arranged within the charging recess in the open state and is guided on a guide device arranged within the charging recess in such a way that it can be displaced under the outer skin surrounding the charging recess opening in the manner of a sliding door. DE 20 2021 001 685 U1 relates to a vehicle flap with an opening and closing device by means of which an opening in a vehicle contour can be exposed or closed. By means of a drivable sliding and pivoting device, a sliding movement of the vehicle flap towards the vehicle interior or vice versa towards the vehicle contour can be realized.

Such inward-opening charging flaps are preferred since outward-opening charging flaps require a larger cutout in the outer skin and are also relevant for the design. The motor vehicle also becomes more vulnerable to vandalism or accidental damage, and the level of innovation is viewed as unimpressive by users.

Vehicles with an inward-opening charging flap have already been proposed in principle in the prior art. However, both the charging flap and the charging socket are located in a wet region of the vehicle body and are mounted from below in the wet space. The body therefore requires a large, high wheel housing at the rear. However, the arrangement of the charging socket in a wet region brings with it disadvantages, such as higher requirements for the tightness of the charging socket and the resulting costs, as well as the need to position high-voltage lines in the wet region, which is undesirable, especially in concepts that aim for the complete arrangement of all high-voltage components in a dry region. Large wheel housings designed to accommodate such a combination of charging socket and charging flap module with charging flap also have disadvantages, such as more complex components and manufacturability, higher weight/higher costs and the limitation of components that can be installed in the interior/dry space.

DE 10 2021 108 061 A1 relates to a hybrid or electric motor vehicle with a body, a body wall which separates a vehicle interior representing a dry region from a body exterior representing a wet region, a through-opening in the body wall which couples the vehicle interior region to the body exterior region, a charging socket unit which closes the through-opening and which comprises a charging socket with a charging plug connection, and a bumper which has an access opening and is attached to the body in such a way that the access opening is at least partially aligned with the through-opening and the charging plug connection is accessible through the access opening for inserting a charging plug. The basic idea is to provide the charging socket unit in a bumper.

DE 10 2021 104 519 A1 relates to a device for opening and closing an access opening in a vehicle body, wherein the access opening leads into an interior with a charging interface. A lid can be adjusted between a closed position and an open position in which the lid is located in the interior by means of a guide device arranged in the interior.

DE 10 2017 212 402 A1 relates to a charging device and an assembly method, wherein, for the purpose of sealing a space located between a wheel housing and a side frame of a motor vehicle in the region of a charging device, the charging pot has at least one sealing means on its side facing the charging socket, which sealing means is arranged at least partially between the charging socket and the wheel housing on its side facing away from the charging pot.

### SUMMARY

The object of the invention is to provide an improved possibility for installing the charging socket for an inward-opening charging flap.

To achieve this object, in a motor vehicle of the type mentioned at the outset, the invention provides that the wheel housing has an inner body section which delimits an inner dry region, and an outer body section which separates a wet region located between the inner and outer body sections from the exterior of the motor vehicle, in such a way that the wet region expands upwards in order to form a charging socket region, wherein the charging socket is installed in an installation opening of the inner body section such that connection cables are guided off in the dry region, the charging flap module is installed in the outer body section such that the closed charging flap covers the charging socket, and the motor vehicle additionally has an adapter which bridges a distance between a connection region of the charging flap module and a connection region of the charging socket in the charging socket region and which provides a seal against moisture.

According to the invention, it is therefore proposed to install the charging socket, despite the existing spacing from the outer body section providing the outer surface of the motor vehicle, in an inner body section that ultimately delimits the motor vehicle interior as a dry space, which makes it possible for the corresponding cabling, i.e. the connecting cables with their charging socket-side connections, to be installed completely in the dry space. Complex measures due to high-voltage components in wet regions can be eliminated. The charging flap, together with the components providing the mechanics as a charging flap module, is installed on the outside, i.e. in the wet space, covering a corresponding charging flap opening of the outer body section. In other words, it can also be said that the subcomponents of the charging flap module and the charging socket, which were previously seen as associated units, are de-coupled according to the present invention in order to combine the inwardly opening charging flap with a charging socket in the dry region.

The charging flap module is located in the wet region of the wheel housing on the outside. The charging socket connections and the connection cables are located in the dry region. In order to bridge the corresponding distance, which usually arises due to design considerations, the invention proposes the use of an adapter which seals in the wet region and at the same time offers the possibility of using the charging socket when the charging flap is open, for example by connecting a plug.

The present invention enables a small, inward-opening charging flap with attractive design, protection from damage and innovation. The charging socket, however, can be located and installed in the dry region, is therefore less complex and more cost-effective and, in particular, enables battery concepts with high-voltage lines that are located entirely in the dry region. The wheel housing can be designed to be compact at the rear inside, thus providing more installation space in the vehicle interior, i.e. in the dry region.

The adapter can have a housing, particularly made of plastic, as moisture protection. This means that the adapter provides sufficient sealing against the remaining wet region in the wheel housing. The housing can, for example, be a plastic casting. The shape of the housing can be adapted to a corresponding mounting region of the charging flap module and/or the charging socket, so that the adapter can be easily “plugged in” and, thanks to the adapted shape, still provides sufficient tightness in wet region. In particular, a form-locking retainer and/or a force-locking retainer, for example by friction, can also be provided on at least one side.

For the specific design of the adapter, it can be provided that the adapter and/or the charging flap module has an electrical adapter unit extending the electrical contacts of the charging socket to the connection region of the charging flap module over at least part of the distance and/or a guide section extending at least over part of the distance and at least partially adapted to the shape of a charging plug. The adapter can therefore expediently comprise an electrical adapter unit, in particular within the housing, so that the adapter can, for example, simply be plugged into the charging socket and provide the charging socket with corresponding electrical contacts, for example for a charging plug of a charging device external to the vehicle, closer to the outside, in particular where the charging socket would be expected in conventional units. In particular, a user may then get the impression that the charging socket is actually located directly and easily accessible behind the flap, even though it is installed in the dry region. Alternatively or additionally, however, at least part of the distance can also be bridged by a guide section of the adapter, which is formed in particular from the housing and which is preferably at least partially adapted to the shape of a charging plug. Despite a possibly increased distance to the electrical contacts behind the charging flap, the charging plug can then be inserted comfortably. In other words, the adapter extends the electrical contacts of the charging socket, to which a charging plug is to be connected, towards the charging flap and/or provides an insertion aid for the plug into the electrical contacts positioned further away from the charging flap. Embodiments are also conceivable in which the electrical adapter unit and/or the guide section are at least partially provided by the charging flap module. In particular, it is also conceivable to provide the adapter only as the sealing housing.

The charging socket can expediently have a liquid drainage, in particular in the wet region, for draining liquid introduced from the outside via the adapter, in particular on the bottom side in a charging recess comprising electrical contacts. Such liquid drainage systems in charging recesses are already known in principle, especially in charging recesses directly adjacent to open charging flaps. Within the scope of the present invention, a liquid drainage system in the charging socket represents a useful addition to the sealing protection of the adapter against the wet region and protects high-voltage contacts and high-voltage components from moisture, for example due to rain or the like.

Advantageously, the charging socket can be installed by means of a sealing device to seal the installation opening in the inner body section and thus the dry region against the wet region. This creates excellent sealing conditions, especially in the region of the high-voltage connections and connection cables of the charging socket. The sealing device can, for example, comprise a flat sealing means and/or a sealing ring. In this context, it can be particularly advantageous to provide for the sealing device or another sealing device to be installed on the adapter. A sealing device already provided on the adapter can, for example, comprise a portion with a circumferential sealing flange that projects through the installation opening into the dry region. For example, the adapter can be inserted first so that the sealing flange is on the inside, and then the charging socket can be mounted. In this way, the charging socket can be provided as the same component, regardless of whether it is used in a wet space or a dry space, without any special modifications required. Additional sealing devices on the adapter may also provide a seal against the charging socket.

In addition to the charging flap, the charging flap module expediently comprises a guide device for at least partially guiding the charging flap when opening, in particular in the manner of a sliding door, under the part of the outer surface of the motor vehicle surrounding the re-leased opening. Purely by way of example, a configuration such as that described in the afore-mentioned DE 10 2015 206 715 A1 can be used. A design according to DE 20 2021 001 685 U1 has also proven to be appropriate. In both cases, however, it is expedient and preferred if the charging flap can be moved laterally in the guide device for opening. In this way, an excessive upward expansion of the wheel housing can be effectively avoided and lateral installation space can be used, which is usually available in sufficient quantity anyway, since the wheel housing can, for example, be expanded upwards over a larger part of its width in the longitudinal direction of the vehicle. Therefore, the ability to open sideways, i.e. in particular a displacement at least essentially in the longitudinal direction of the vehicle, has the least impact on the external design of the motor vehicle and the otherwise available installation space.

The inner body section separates the wet region from the dry region. It can be implemented in different ways, for example comprising at least one body component, in particular made of metal, and/or a separating plate and/or a plastic assembly part. The use of a plastic assembly part makes it possible, for example, to save or extend an inner body component of the wheel housing to create the charging socket region, since only the plastic assembly part then has to be attached to the inner body component of the rear wheel housing. However, it is also conceivable to continue the inner body component of the wheel housing upwards and/or to supplement it with an additional body component. In some embodiments, a simpler implementation than a partition plate can also be provided, especially if only light or no forces have to be carried.

The charging flap module can conveniently be enclosed by a side wall frame. This means that the outer body section can, as has already been proposed in the prior art, comprise a side wall frame of the motor vehicle in which the charging flap opening is provided for installing the charging flap module. The side wall frame can be formed by a body component. For example, the side wall frame can be designed as an assembly part, in particular made of plastic or metal, and/or form a type of rear fender. In principle, it is also conceivable to ultimately con-struct the outer body section in multiple layers, for example by partially overlapping the side wall frame and an outer body component of the rear wheel housing.

### BRIEF DESCRIPTION OF THE FIGURES

Further advantages and details of the present invention will be apparent from the exemplary embodiments described below and based on the drawings. In particular:

FIG. 1 is a simplified schematic view in principle of a motor vehicle according to the invention,

FIG. 2 is a cross-sectional view in the region of a rear wheel housing,

FIG. 3 is a perspective view of components in the rear wheel housing region,

FIG. 4 is an alternative embodiment of an adapter, and

FIG. 5 is a schematic view of a sealing device provided as part of an adapter.

### DETAILED DESCRIPTION

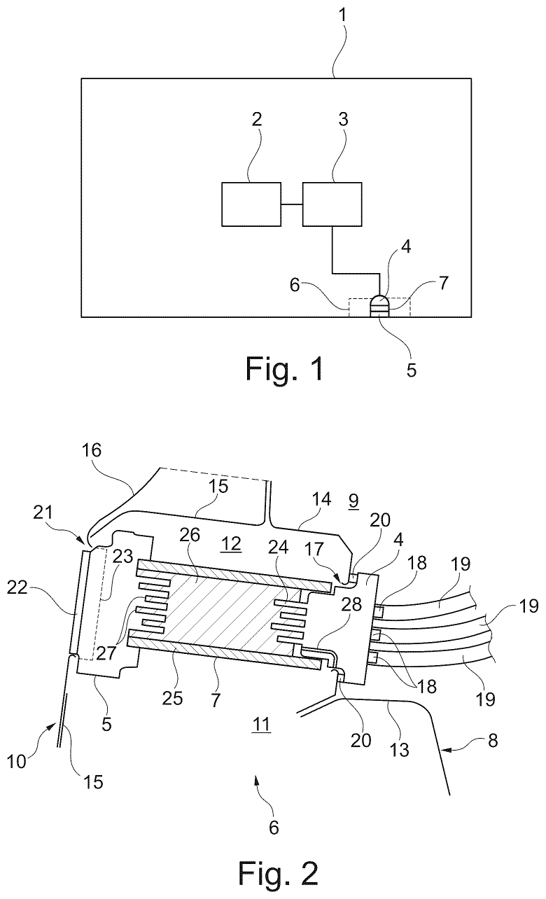

FIG. 1 shows a schematic view in principle of a motor vehicle 1 according to the invention, here an electric vehicle. The electric motor vehicle 1 has an electric battery 2 as a traction battery for operating an electric drive machine. The electric battery 2 is therefore a high-voltage battery. This can be charged by means of an internal charging device 3 (on-board charger) and a charging socket 4 from an external charging device, for example a charging station. A charging flap module 5 with a charging flap, which is provided above a rear wheel on the side of the motor vehicle 1, provides lockable access to the charging socket 4, which is installed in a dry region of the rear wheel housing 6, which is only indicated here, and is connected to the charging flap module 5 via an adapter 7 in a wet region, bridging the distance to the latter. This is shown in more detail in the cross-sectional view of FIG. 2.

FIG. 2 shows a simplified cross-section through an upper part of the rear wheel housing 6. It can be seen that the wheel housing is delimited in the present case by an inner body section 8 to form a dry region 9, which corresponds to the motor vehicle interior, and to the outside by an outer body section 10 in such a way that a wet region 11 is formed between the inner body section 8 and the outer body section 10, which wet region is expanded upwards by a charging socket region 12. In this case, the inner body section 8 is formed by body components 13, 14, namely a body component 13 “rear inner wheel housing” and a body component 14 “rear inner side”. In other exemplary embodiments, the body component 14 can also be supplemented or replaced by a plastic assembly part.

The outer body section 10 comprises here a body component 15 (“rear outer wheel housing”) and a side wall frame 16.

The inner body component 14 has an installation opening 17 in which the charging socket 4 is installed in such a way that its connections 18 and the associated (high-voltage) connection cables 19 are completely in the dry region 9. The dry region 9 is also sealed from the wet region 11 by a sealing device 20, which may, for example, comprise a flat sealing means which lies between a shoulder of the charging socket 4 and the body component 14. Other designs of the sealing device 20 are also conceivable. For example, the sealing device 20 can also be attached directly to the adapter 7, thus being provided as part of the adapter 7. The sealing device 20 can then, for example, have a portion projecting through the installation opening 17 with a sealing flange resting on the body component 14 on the side of the dry region 9.

The charging flap module 5 is installed in a charging flap opening 21 of the outer body section 10 in such a way that it is enclosed by the side wall frame 16. It comprises the charging flap 22, shown here in the closed position flush with the side wall frame 16, and a device for opening and closing the charging flap 22, which in particular has a guide device 23 (only indicated in FIG. 2) in which the charging flap 22 is guided in such a way that it can be displaced laterally under the surrounding outer surface of the motor vehicle, in particular the outer body section 10, in the manner of a sliding door.

The charging socket has electrical contacts 24 in a connection region, which are provided at a distance from a desired connection region of the charging flap module 5. Therefore, in the exemplary embodiment shown here, the adapter 7 not only has a housing 25, for example made of plastic, which acts as a seal against the wet region 11, but also an electrical adapter unit 26, which can be plugged onto the contacts 24 and bridges the distance in which corresponding electrical contacts 27 of the electrical adapter unit 26 are provided on the other side.

In order to drain any liquid that may penetrate through the charging flap module 5 and the adapter 7, the charging socket 4 can have a liquid drain 28 into the wet space. Alternatively, the liquid drain 28 can also be provided in the adapter 7.

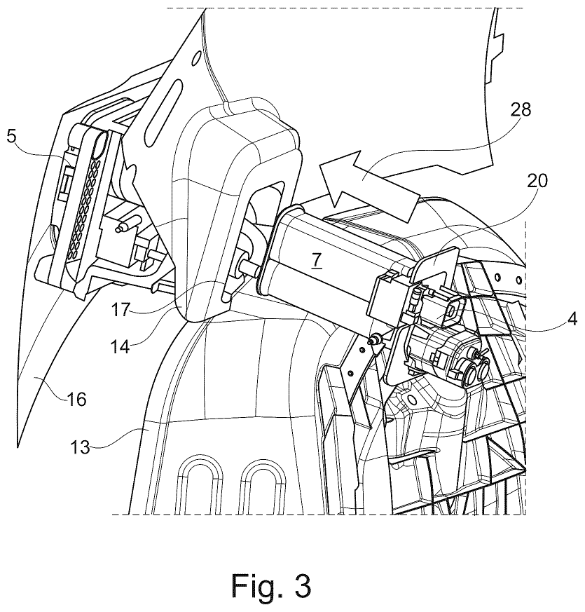

FIG. 3 shows a schematic, perspective view for the installation of adapter 7 and charging socket 4, wherein the body component 15 is not shown for the sake of clarity. As can be seen, the charging flap module 5 is already installed in the side wall frame 16 and the adapter 3 is placed on the charging socket 4. The sealing device 20 is also shown. To achieve the installation state, the adapter 7 and the charging socket 4 must be inserted through the installation opening 17 as shown by the arrow 28.

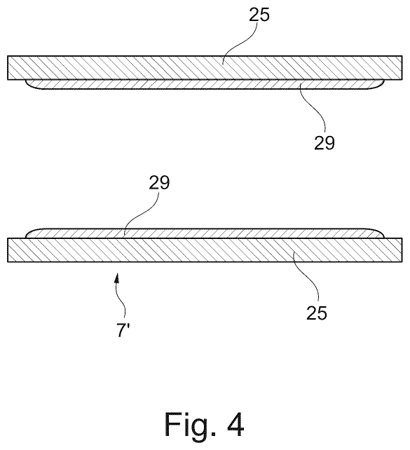

FIG. 4 shows a further, modified embodiment of an adapter 7′, which instead of the electrical adapter has a guide section 29, formed in the present case from the housing 25, for a plug to be connected to the charging socket 4. Embodiments are also conceivable in which the adapter 7, 7′ has both an electrical adapter unit 26 and a guide section 29, each of which bridges parts of the distance.

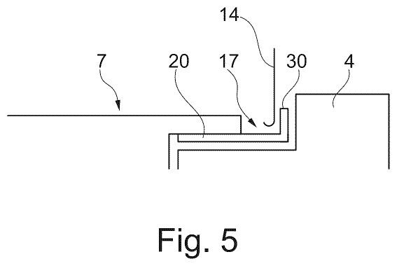

FIG. 5 schematically shows an embodiment in which the sealing device 20 is provided on the adapter 7 and has a portion extending through the installation opening 17 with a sealing flange 30.

1-9. (canceled)

10. A motor vehicle having a charging socket for a battery installed in the motor vehicle, in particular a traction battery, a body with a rear wheel housing of a rear wheel, above which the charging socket is installed in the body, and a charging flap module with a charging flap which outwardly covers the charging socket and which opens inwards,
wherein the wheel housing has an inner body section which delimits an inner dry region and an outer body section, which separates a wet region located between the inner and outer body section from the exterior of the motor vehicle, such that the wet region expands upwards in order to form a charging socket region, wherein the charging socket is installed in an installation opening of the inner body section such that connection cables are guided off in the dry region, the charging flap module is installed in the outer body section such that the closed charging flap covers the charging socket, and the motor vehicle additionally has an adapter which bridges the distance between a connection region of the charging flap module and a connection region of the charging socket in the charging socket region and which provides a seal against moisture.

11. The motor vehicle according to claim 10, wherein the adapter has a housing, in particular made of plastic, as moisture protection.

12. The motor vehicle according to claim 10, wherein the adapter and/or the charging flap module has an electrical adapter unit extending electrical contacts of the charging socket to the connection region of the charging flap module over at least part of the distance and/or a guide section extending at least over part of the distance and at least partially adapted to the shape of a charging plug.

13. The motor vehicle according to claim 10, wherein the charging socket can expediently have a liquid drainage, in particular in the wet region, for draining liquid introduced from the outside via the adapter, in particular on the bottom side in a charging recess comprising electrical contacts.

14. The motor vehicle according to claim 10, wherein the charging socket is installed by means of a sealing device to seal the installation opening in the inner body section and thus the dry region against the wet region.

15. The motor vehicle according to claim 10, wherein the charging flap module has a guide device for at least partially guiding the charging flap when opening, in particular in the manner of a sliding door, under the part of the outer surface of the motor vehicle surrounding the released opening.

16. The motor vehicle according to claim 15, wherein the charging flap can be moved laterally in the guide device for opening.

17. The motor vehicle according to claim 10, wherein the inner body section comprises at least one body component and/or a partition plate and/or a plastic assembly part.

18. The motor vehicle according to claim 10, wherein the charging flap module is enclosed by a side wall frame.

19. The motor vehicle according to claim 11, wherein the adapter and/or the charging flap module has an electrical adapter unit extending electrical contacts of the charging socket to the connection region of the charging flap module over at least part of the distance and/or a guide section extending at least over part of the distance and at least partially adapted to the shape of a charging plug.

20. The motor vehicle according to claim 11, wherein the charging socket can expediently have a liquid drainage, in particular in the wet region, for draining liquid introduced from the outside via the adapter, in particular on the bottom side in a charging recess comprising electrical contacts.

21. The motor vehicle according to claim 12, wherein the charging socket can expediently have a liquid drainage, in particular in the wet region, for draining liquid introduced from the outside via the adapter, in particular on the bottom side in a charging recess comprising electrical contacts.

22. The motor vehicle according to claim 11, wherein the charging socket is installed by means of a sealing device to seal the installation opening in the inner body section and thus the dry region against the wet region.

23. The motor vehicle according to claim 12, wherein the charging socket is installed by means of a sealing device to seal the installation opening in the inner body section and thus the dry region against the wet region.

24. The motor vehicle according to claim 13, wherein the charging socket is installed by means of a sealing device to seal the installation opening in the inner body section and thus the dry region against the wet region.

25. The motor vehicle according to claim 11, wherein the charging flap module has a guide device for at least partially guiding the charging flap when opening, in particular in the manner of a sliding door, under the part of the outer surface of the motor vehicle surrounding the released opening.

26. The motor vehicle according to claim 12, wherein the charging flap module has a guide device for at least partially guiding the charging flap when opening, in particular in the manner of a sliding door, under the part of the outer surface of the motor vehicle surrounding the released opening.

27. The motor vehicle according to claim 13, wherein the charging flap module has a guide device for at least partially guiding the charging flap when opening, in particular in the manner of a sliding door, under the part of the outer surface of the motor vehicle surrounding the released opening.

28. The motor vehicle according to claim 14, wherein the charging flap module has a guide device for at least partially guiding the charging flap when opening, in particular in the manner of a sliding door, under the part of the outer surface of the motor vehicle surrounding the released opening.

29. The motor vehicle according to claim 11, wherein the inner body section comprises at least one body component and/or a partition plate and/or a plastic assembly part.
